(19) United States
(12) Patent Application Publication
(10) Pub. No.: US 2013/0230305 A1
(43) Pub. Date: Sep. 5, 2013

(54) FLASH APPARATUS AND METHOD FOR CONTROLLING THE COLOUR TEMPERATURE OF LIGHT IN A FLASH

(71) Applicants: Anton Falk, Huddinge (SE); Ulf Carlsson, Stockholm (SE); Bo Dalenius, Enskede (SE); Göran Marén, Vendelso (SE)

(72) Inventors: Anton Falk, Huddinge (SE); Ulf Carlsson, Stockholm (SE); Bo Dalenius, Enskede (SE); Göran Marén, Vendelso (SE)

(73) Assignee: PROFOTO AB, Sundbyberg (SE)

(21) Appl. No.: 13/811,245

(22) PCT Filed: Jul. 11, 2011
(86) PCT No.: PCT/SE11/50942

§ 371 Date: Apr. 5, 2013

Related U.S. Application Data
(60) Provisional application No. 61/365,793, filed on Jul. 20, 2010.

(30) Foreign Application Priority Data
Jul. 20, 2010 (SE) 1050817-4

(51) Int. Cl. G03B 15/05

(52) U.S. Cl. CPC G03B 15/05
USPC 396/164

(57) ABSTRACT

A flash apparatus comprising at least two flash tubes and at least two energy storage units is presented, wherein each of said at least two energy storage units is being arranged to be configured to strictly correspond to one of the at least two flash tubes for a flash. The flash apparatus is configured to control the amount of energy provided by the at least two energy storage unit(s) to their corresponding flash tube and control the flash duration of the corresponding flash tube dependent of each other, respectively for each flash tube, so as to obtain substantially the same colour temperature from each flash tube for a flash. A method and a computer program product for use in the flash apparatus are also presented.

### TECHNICAL FIELD

The invention relates in general to generating a flash and in particular to a flash apparatus. The invention also relates to a method for controlling the colour temperature of light in a flash and a computer program product for use in the flash apparatus.

### BACKGROUND

Generally, in a flash apparatuses, it is desirable to control the amount of energy provided to the flash tube comprised in the flash apparatuses as well as the colour temperature of the resulting emitted light from said flash tube.

A flash apparatus typically comprises an energy source C configured to feed energy to a flash tube for a flash. The flash tube discharge by igniting ignition circuits inside the flash tube and thus drains the energy source C. The energy source C is typically a capacitive element, such as, a capacitor. A first method of controlling the amount of energy provided to a single flash tube and the colour temperature of the emitted light from the single flash tube is illustrated in FIGS. 1A-1B. In FIG. 1A, by charging the energy source C up to a particular charging voltage, an amount of energy corresponding to the energy level E_{C} is stored in the energy source C. When said amount of energy E_{C} is provided to the flash tube, the resulting emitted light from the flash tube will have the desired colour temperature T_{des}. If the energy source C is instead charged up to a lower charging voltage, a lower amount of energy corresponding to the energy level E_{des} is stored in the energy source C. Thus, when said lower amount of energy E_{des} is provided to the flash tube, the resulting emitted light from the flash tube will instead have the colour temperature T_{B}. However, it may often be desirable to achieve the desired colour temperature T_{des} of the resulting emitted light from the flash tube, but while only providing the amount of energy E_{des} to the flash tube.

In FIG. 1B, the energy source C is charged to a particular charging voltage V corresponding to an amount of energy E_{des}+E′. As the amount of energy in the energy source C is drained by the flash tube, the discharge of energy is interrupted at time t₁ when the amount of already discharged energy by the flash tube corresponds to the desired amount of energy E_{des}. This will result in that the remaining amount of energy E′ is cut off and not discharged by the flash tube. Consequently, the emitted light from the flash tube will have the colour temperature T₁. According to the inherent relationships shown in FIG. 1B, a particular charging voltage V and a discharge interruption timing t₁ can be found such that the amount of energy provided to the flash tube is E_{des} and the color temperature T₁ is approximately the same as T_{des}, i.e. T₁≈T_{des}. Thus, in case of using a single flash tube, it is in this manner possible to provide a desired amount of energy E_{des} to the flash tube and still achieve the desired colour temperature T_{des} of the resulting emitted light, as shown by the arrow in FIG. 1A.

A second method of controlling the amount of energy provided to a single flash tube and the colour temperature of the emitted light from the single flash tube is to have a set or bank of different energy storage sources, e.g. C₁-C₃, which are configured to provide energy to the single flash tube for the flash. This is illustrated in FIGS. 2A-2B. A given energy storage source, e.g. C₃, of a particular energy storage size being charged to a particular charging voltage V₃ corresponding to an energy level E₃ will generate a particular colour temperature T_{des} of the emitted light when provided to a single flash tube at a flash instance. Here, if a different amount of energy is desired to be provided to the flash tube for the flash, while keeping the colour temperature T_{des} of the emitted light, any one of the different energy storage sources C₁-C₃ may be used separately or be combined to provide the desired amount of energy. However, since the number of energy storage sources C₁-C₃ in the set is finite due to the inherent implementational and economic considerations of having a large amount of capacitors, only finite number of discrete energy levels, e.g. E₁, E₂, E₃, E₁+E₂, E₁+E₃, E₂+E₃, E₁+E₂+E₃, will be possible for the desired color temperature T_{des}.

However, in case of having a flash apparatus which comprises more than a single flash tube, both of the methods described above suffers from disadvantages. For example, by using the first method described above in reference to FIGS. 1A-1B in the case of having more than a single flash tube, the amount of energy E_{C} could be arranged to be divided between two flash tubes, e.g. one flash tube may be arranged to receive E_{des} and another flash tube may be arranged to receive E′. However, the light from the flash tube which is determined to receive the lower amount of energy, e.g. E′, from the energy source C than the other flash tube will always comprise a colour temperature T₂ that is lower than the colour temperature T₁ of the light from the other flash tube determined to receive the higher amount of energy E_{des} from the energy source C. Therefore, the emitted light from a flash apparatus comprising more than one flash tube and using the first method will comprise substantially different colour temperatures when emitted from more than a single flash tube.

Furthermore, achieving according to the second method a desired color temperature T_{des} for a continuous, non-discrete range of energy levels E for even a single flash tube is not a scalable or cost efficient solution. Therefore, the second method is also not a viable solution for a flash apparatus which comprises more than a single flash tube.

### SUMMARY

It is understood by the inventor that it is highly desirable to provide a flash apparatus comprising at least two flash tubes capable of emitting light from the at least two flash tubes having substantially the same colour temperature during a flash.

This issue is addressed by a flash apparatus comprising at least two flash tubes and at least two energy storage units, each of said at least two energy storage units is being arranged to be configured to strictly correspond to one of the at least two flash tubes for a flash, wherein said flash apparatus is configured to control the amount of energy provided by at least two energy storage unit(s) to their corresponding flash tube and control the flash duration of the corresponding flash tube dependent of each other, respectively for each flash tube, so as to obtain substantially the same colour temperature from each flash tube for a flash.

By controlling the amount of energy delivered to a specific flash tube, by e.g. varying the number of energy storage units being dedicated thereto and their charging voltages, and controlling the flash duration of the specific flash tube in dependence of one another, respectively, for all of the at least two flash tubes, substantially the same colour temperature from all of the at least two flash tubes for a complete flash instance may be obtained. This is a highly desirable feature of a flash apparatus from a photographer's point of view since it enables a more predictable and reliable flash when taking a photograph using more than one flash tube or bulb.

Another advantage of the flash apparatus is that it provides a truly assymmetrical, multiple output flash generator which enables the mixing of several different kinds of flash tubes or bulbs.

A further advantage of the flash apparatus is that it provides a more practical and cost efficient solution, since it allows a photographer to freely select amongst a larger number of variables (e.g. which flash tube or bulb to use, amount of energy to be used in the flash by each flash tube or bulb, etc.) and may also reduce the amount of necessary components to be used in a flash apparatus.

The flash duration for each flash tube may further be determined by the flash apparatus based on a desired amount of energy to be respectively provided by the energy storage units to their corresponding flash tube and the colour temperature. This allows, for example, for a photographer to be able to independently determine the amount of energy he wants to provide to each of a plurality of flash tubes in order to achieve his desired flash of light without having to risk having different colour temperatures of the light being emitted by each of a plurality of flash tubes.

Furthermore, the amount of energy from each of the energy storage units provided to their corresponding flash tube may be controlled by the flash apparatus by determining charging voltages for each of the energy storage units and modifying the output of the corresponding energy storage units to each flash tube. Since the energy storage units may comprise different maximum charging voltages and/or be charged to a specific charging voltage below its maximum charging voltage, and the outputs from one or more of the energy storage units may be selectively combined in numerous different ways to provide energy to a specific flash tube, the desired amount of energies may always be provided to the at least two flash tube for each flash. This may further be implemented by using a charge voltage setting means in the flash apparatus that is configured to charge the corresponding energy storage units for each flash tube up to the determined charging voltages. The charge voltage setting means may be configured to be connected to or incorporated in a single charging unit. This enables an easy and simple way to provide the right amount of energy to each of the corresponding energy storage units to be used for the flash.

The flash apparatus may also comprise output modification means configured to modify the output of the corresponding energy storage units to the flash tubes by selectively connecting the outputs of the corresponding energy storage units to inputs of each of the flash tubes, respectively. This enables an easy and simple way to ensure that the right amount of energy from the energy storage units is delivered to their corresponding flash tube.

The flash apparatus may further comprise flash duration control means configured to control each of the flash tubes to be activated according to the determined flash durations by selectively connecting and disconnecting of the inputs of each flash tube from the outputs of the corresponding energy storage units. This enables an easy and simple way to ensure that the correct flash duration is achieved for each of the flash tubes.

The amount of energy to be provided from each of the corresponding energy storage units to each flash tube in the flash apparatus may further be based on the discharge characteristics of the flash tubes that are actually used, the impedance of capacitors of the corresponding energy storage units, and/or further impedances present in the flash apparatus. This may further improve the correspondence of the substantially the same colour temperature of the at least two flash tubes. Additionally, each of the at least two flash tubes may be exchangeable flash tubes or bulbs which comprise an impedance, a size and/or a shape that is different in respect to each other. This may provide a photographer with an extended range of possibilities in selecting which types of flash tube to be used in the flash lighting of a photograph.

According to another aspect of the invention, a method for use in a flash apparatus is provided comprising at least two flash tubes and at least two energy storage units is provided, each of said at least two energy storage units is being arranged to be configured to strictly correspond to one of the at least two flash tubes for a flash, said method comprising the step of: controlling the amount of energy provided by the at least two energy storage unit(s) to their corresponding flash tube and controlling the flash duration of the corresponding flash tube dependent of each other, respectively for each flash tube, so as to obtain substantially the same colour temperature from each flash tube for a flash.

According to a further aspect of the invention, a computer program product for use in a flash apparatus comprising at least two flash tubes and at least two energy storage units is provided, each of said at least two energy storage units is being arranged to be configured to strictly correspond to one of the at least two flash tubes for a flash, said computer program product comprising computer readable code means, which when run in a control unit in the flash apparatus causes said flash apparatus to perform the step of: controlling the amount of energy provided by the at least two energy storage unit(s) to their corresponding flash tube and controlling the flash duration of the corresponding flash tube dependent of each other, respectively for each flash tube, so as to obtain substantially the same colour temperature from each flash tube for a flash.

Further advantageous embodiments of the method and computer program product are set forth in the dependent claims and correspond to the advantageous embodiments already set forth with reference to the previously mentioned flash apparatus.

### BRIEF DESCRIPTION OF THE DRAWINGS

The objects, advantages and effects as well as features of the invention will be more readily understood from the following detailed description of exemplary embodiments of the invention when read together with the accompanying drawings, in which:

FIGS. 1A and 1B shows schematic graphs illustrating a first method of controlling the amount of energy provided to and the colour temperature of the emitted light from a single flash tube according to a prior art example.

FIGS. 2A and 2B shows schematic graphs illustrating a second method of controlling the amount of energy provided to and the colour temperature of the emitted light from a single flash tube according to a prior art example.

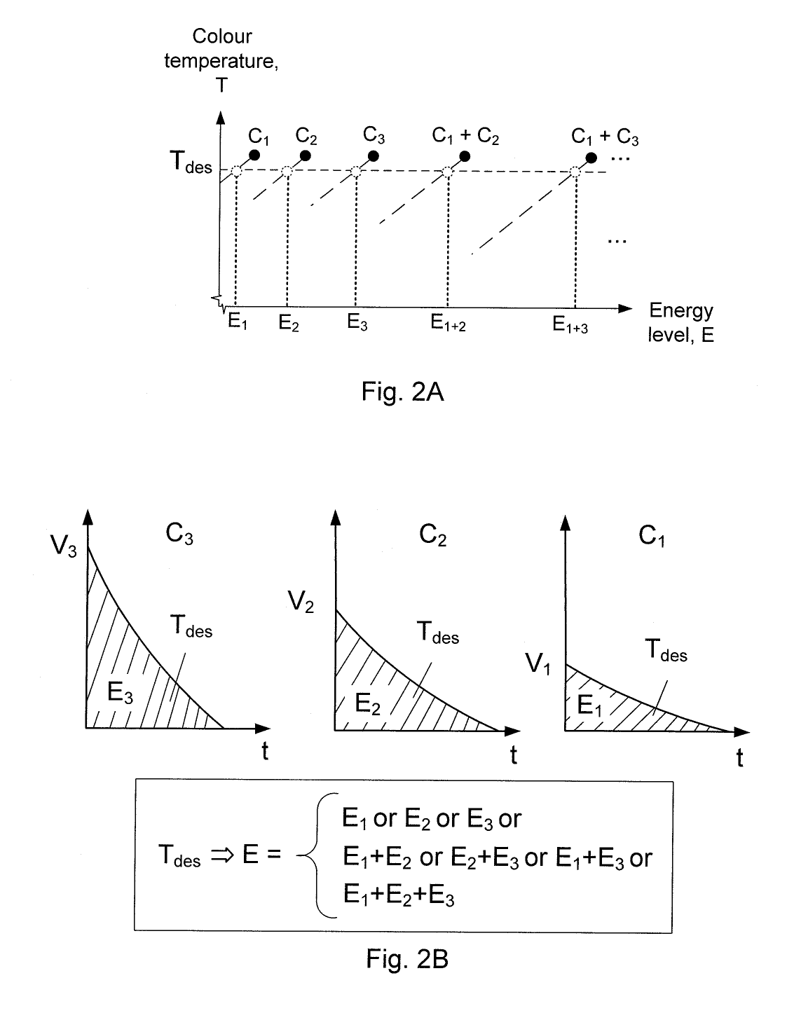

FIG. 3 illustrates a flash apparatus comprising two or more flash tubes according to an embodiment of the invention.

FIG. 4 shows schematic graphs illustrating an operation of the flash apparatus in FIG. 3 according to an embodiment of the invention.

FIG. 5 shows a flowchart illustrating a method according to an embodiment of the invention.

FIG. 6 shows a flowchart illustrating a method according to another embodiment of the invention.

### DETAILED DESCRIPTION

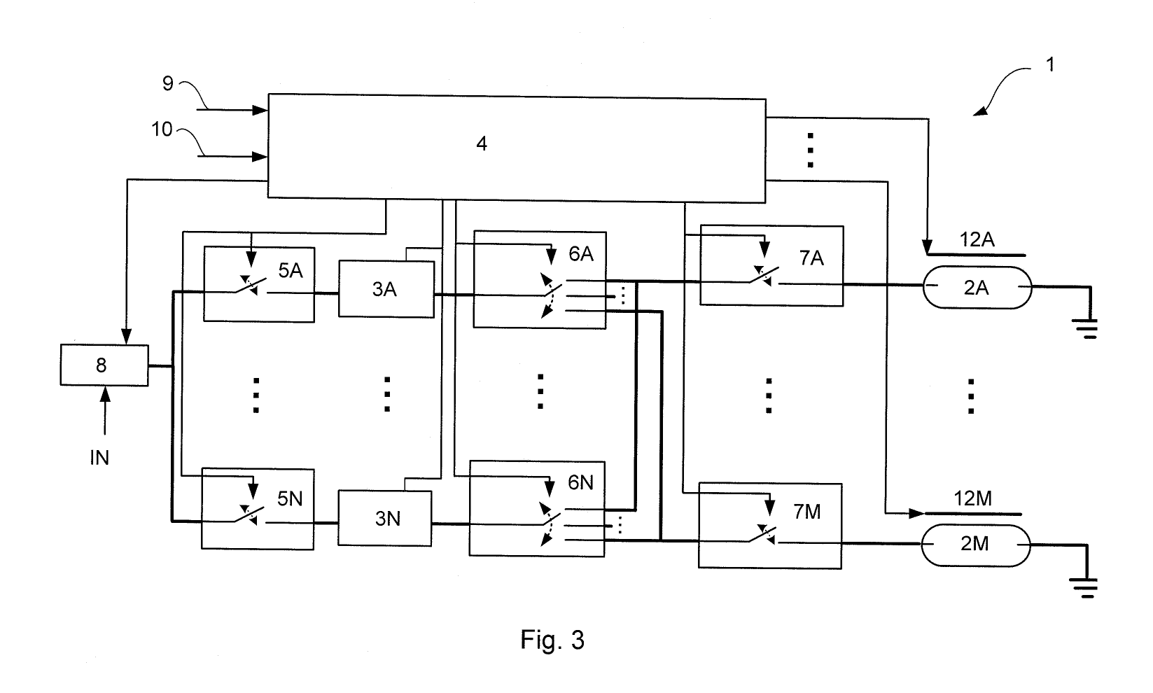

FIG. 3 illustrates a flash apparatus 1 according to an embodiment of the invention. The flash apparatus 1 may comprise a control unit 4, a charging unit 8, a charge voltage setting means 5, an energy storage means 3, an output modification means 6, a flash duration control means 7, and two or more flash tubes 2. These parts of the flash apparatus 1 may be provided as individual modules arranged to be connected with each other or may be provided as a single discrete unit, as shown in FIG. 3.

The charging unit 8 is arranged to be connected to the mains, an electric generator or similar energy source in order to receive an input voltage. The input voltage may be DC-voltage or AC-voltage, and may deliver one-phase, two-phase or three-phase electric power. The charging unit 8 is also configured to be connected to the charge voltage setting means 5. The charging unit 8 is configured to convert the received input voltage into an output voltage and provide the output voltage to the charge voltage setting means 5. The output voltage may be determined and controlled by the control unit 4 from which the charging unit 8 may be arranged to receive control signals.

The charge voltage setting means 5 may comprise n number of charging switches 5A, . . . , 5N. Each of the charging switches 5A, . . . , 5N may be arranged to receive an output voltage from the charging unit 8. Each of the charging switches 5A, . . . , 5N may be configured to connect or disconnect the output voltage from the charging unit 8 to an input of a corresponding one of the energy storage units 3A, . . . , 3N. This may be performed in response to control signals received from the control unit 4.

The energy storage means 5 may comprise n number of energy storage units 3A, . . . , 3N. The energy storage units 3A, . . . , 3N may be arranged to receive output voltages from the charging switches 5A, . . . , 5N. The energy storage units 3A, . . . , 3N may be capacitive elements that are arranged to be charged upon receiving the output voltage from the charging switches 5A, . . . , 5N. The charging voltages of the energy storage units 3A, . . . , 3N, later referred to herein, may be the charged voltage levels of the capacitive elements. These capacitive elements may typically be capacitors with defined capacitances of different sizes. As described below, the energy storage units 3A, . . . , 3N may be chosen for each of the two or more flash tubes 2 by the control unit 4 so as to provide the best possible combinational effect as regards colour temperature, flash duration and energy level. Each of the energy storage units 3A, . . . , 3N may thus be configured to provide an output voltage to a corresponding output switch 6A, . . . , 6N in the output modification means 6.

The output modification means 6 may comprise n number of output switches 6A, . . . , 6N. The output switches 6A, . . . , 6N may each be configured to receive an output voltage from a corresponding energy storage unit 3A, . . . , 3N. Each of the output switches 6A, . . . , 6N may comprise individual outputs to each of an m number of flash duration switches 7A, . . . , 7M in the flash duration control means 7. Each of the output switches 6A, . . . , 6N may be arranged to connect or disconnect the output voltage from its corresponding energy storage unit 3A, . . . , 3N to any one of the individual outputs towards each of the m number of flash duration switches 7A, . . . , 7M of the flash duration control means 7. This may be performed in response to control signals received from the control unit 4.

The flash duration means 7 may comprise m number of flash duration switches 7A, . . . , 7M, wherein m≧2. The flash duration switches 7A, . . . , 7M may each be configured to receive an output voltage from one or several of the output switches 6A, . . . , 6N of the output modification means 6. Each of the flash duration switches 7A, . . . , 7M may be arranged to connect or disconnect the output voltage received from the one or several of the output switches 6A, . . . , 6N of the output modification means 6 to a corresponding one of the at least two flash tubes 2A, . . . , 2M. This may be performed in response to control signals received from the control unit 4. The flash tubes 2 may also comprise m number of flash tubes 2A, . . . , 2M, wherein m≧2. It should be noted that the flash duration means 7 may also be located on the other side of its corresponding one of the at least two flash tubes 2A, . . . , 2M in FIG. 3, that is, located between its corresponding one of the at least two flash tubes 2A, . . . , 2M and the connection to ground (GND).

The flash tubes 2A, . . . , 2M may each be configured to receive an output voltage from a corresponding one of the flash duration switches 7A, . . . , 7M in the flash duration means 7. The flash tubes 2A, . . . , 2M may comprise exchangeable flash tubes or bulbs. Each of the flash tubes 2A, . . . , 2M may comprise different individual impedances, be of individually different sizes and/or be of individually different shapes in respect to each other. Each of the flash tubes 2A, . . . , 2M may also be arranged to discharge the received output voltage in the flash tube upon ignition by an ignition means 12A, . . . , 12M comprised therein. Thus, the flash tubes 2A, . . . , 2M are configured to drain the corresponding energy storage units 3A, . . . , 3N that are selectively connected to each flash tube 2A, . . . , 2M through the output modification means 6 and the flash duration means 7 upon ignition. The ignition of the flash tubes 2A, . . . , 2M by the ignition means 12A, . . . , 12M may be performed in response to control signals received from the control unit 4. Thus, energy will flow from the corresponding energy storage units 3A, . . . , 3N to each selectively connected flash tube 2A, . . . , 2M until the corresponding energy storage units 3A, . . . , 3N are depleted or until the flash duration switches 7A, . . . , 7M disconnects the output voltage of one or several of the output switches 6A, . . . , 6N of the output modification means 6 from each flash tube 2A, . . . , 2M.

The control unit 4 may be communicatively connected to and be arranged to send control signals to the charging unit 8, the charge voltage setting means 5, the output modification means 6, the flash duration means 7 and the at least two flash tubes 2. It should be noted that the control unit 4 may be provided as a single physical unit, for example, a central processing unit (CPU) or computer processor. The control unit 4 may also comprise processing means or logic for performing the necessary calculations for the functionality of the flash apparatus 1. This may be implemented partly by means of a software or computer program. The control unit 4 may also comprise a readable storage medium, such as, a memory unit, for storing such computer programs and also a processing unit, such as a microprocessor, for executing the computer program stored on the readable storage medium. Alternatively, the memory unit may be separated from, but connected to the control unit 4. When, in the following, it is described that the control unit 4 performs a certain function or operation it is to be understood that the control unit 4 may use the processing means or logic comprised therein to execute a certain part of the computer program which is stored in the memory unit.

The control unit 4 may also be arranged to receive input signals 9 and a synchronisation signal 10. The input signals 9 and synchronisation signal 10 may, for example, be provided by a camera apparatus connected to the flash apparatus 1, or a control interface of the flash apparatus 1 and/or an actuator of the flash apparatus 1 that may be controlled by an operator of the flash apparatus 1. The synchronisation signal 10 may indicate to the control unit 4 to begin to discharge the charged energy of the energy storage units 3A, . . . , 3N through their corresponding flash tube 2A, . . . , 2M, that is, to initiate and generate a flash by the flash apparatus 1. The input signals 9 may comprise input parameters such as desired energy amounts and a desired colour temperature setting. The control unit 4 may also comprise default values of the input parameters such as desired energy amounts and a desired colour temperature setting. The desired energy amounts indicate the desired amount of energy to be delivered to each flash tube 2A, . . . , 2M. The desired amounts of energy may, for example, be individual set for each flash tube 2A, . . . , 2M, or be a single energy amount setting for all flash tubes 2A, . . . , 2M. The two desired amounts of energy may be indicated by an operator in, for example, F-stops, Joules (J), Watt seconds (Ws) or in any other suitable energy scale.

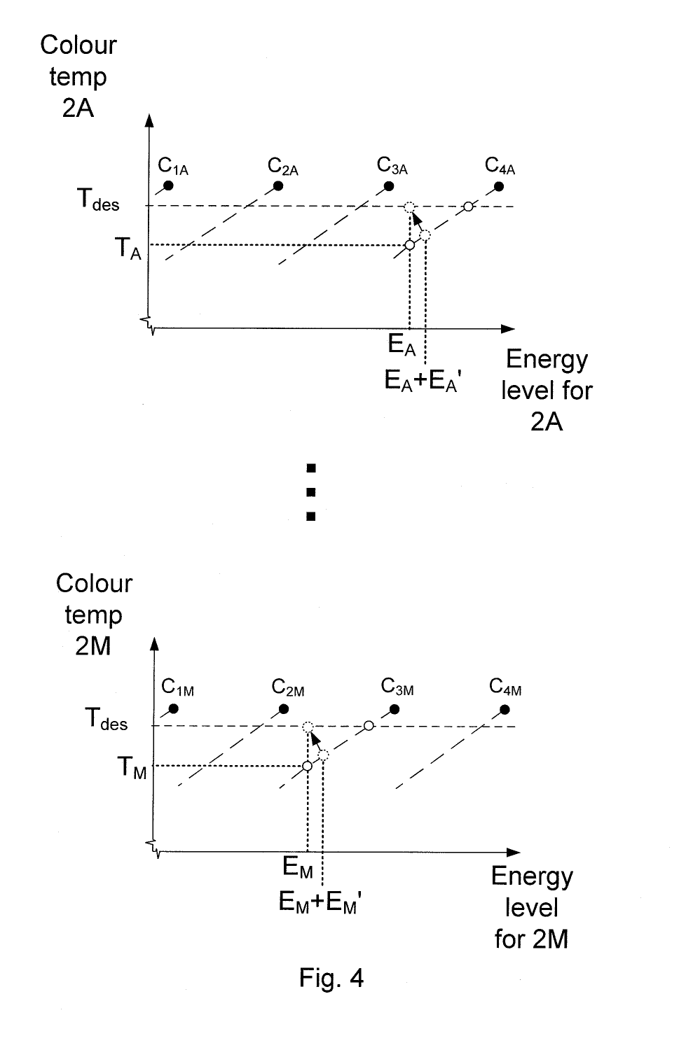

Based on the desired energy amounts and the desired colour temperature setting, the control unit 4 is configured to determine the total capacitance size for each of the at least two flash tubes 2A, . . . , 2M (that is, which and how many of the energy storage units 3A, . . . , 3N are needed and should be used for each of the at least two flash tubes 2A, . . . , 2M), determine the input voltages Vₒₚₜ for each of the at least two flash tubes 2A, . . . , 2M, and determine the discharge interruption times tₒₚₜ for each of the at least two flash tubes 2A, . . . , 2M. Thus, the control unit 4 may determine, dependent upon each other, a specific amount of energy to be delivered to a first flash tube 2A and a specific flash duration for the first flash tube 2A such that the desired colour temperature of the light emitted from the first flash tube 2A for a flash instance is achieved; this, while at the same time also determining, dependent upon each other, a specific amount of energy to be delivered to a second flash tube 2M and a specific flash duration for the second flash tube 2M such that the desired colour temperature of the light emitted from the second flash tube 2M is achieved for the same flash instance. This is illustrated in more detail in FIG. 4. Thereby, substantially the same colour temperature from each flash tube 2A, . . . , 2M may be obtained for a flash in the flash apparatus 1.

It should also be noted that upon determining the total capacitance size, the determine input voltages Vₒₚₜ and the discharge interruption times tₒₚₜ, the control unit 4 may also take into consideration the discharge characteristics of the current flash tubes 2A, . . . , 2M that are actually used in the flash apparatus 1, the impendances of the capacitors of the energy storage units 3A, . . . , 3N, and/or other impedances inherent in the circuit of the flash apparatus 1.

Based on the determined total capacitance sizes and the determined input voltages Vₒₚₜ, the control unit 4 may send control signals to the charge voltage setting means 5 indicating which of the energy storage units 3A, . . . , 3N that are selected to be charged and how much each of these selected energy storage units 3A, . . . , 3N is to be charged. This may, for example, be performed by the control unit 4 by sending signals indicating to each of the charging switches 5A, . . . , 5N when to connect and disconnect. The control unit 4 may then continuously measure and monitor the charging voltages of the energy storage units 3A, . . . , 3N, e.g. the charged voltage levels of the capacitive elements. Further, the control unit 4 may send control signals to the output modification means 6 indicating which individual output each of the selected energy storage units 3A, . . . , 3N should be connected to. This may, for example, be performed by the control unit 4 by sending control signals to each of the output switches 6A, . . . , 6N indicating the individual outputs to which each of the output switches 6A, . . . , 6N is to switch and connect to. This may be performed prior to or upon receiving the synchronisation signal 10 in the control unit 4 indicating the initiation and generation of the flash. Note that for a single flash or flash instance, an energy storage unit 3A, . . . , 3N may only be connected so as to provide energy to one of the flash tubes 2A, . . . , 2M.

The control unit 4 may further be configured to send control signals to the charging unit 8 indicating a desired output voltage and when to begin providing the desired output voltage to the charge voltage setting means 5.

Furthermore, based on the determined discharge interruption times tₒₚₜ for each of the at least two flash tubes 2A, . . . , 2M, the control unit 4 may be configured to send control signals to the flash duration means 7 indicating to each of the flash duration switches 7A, . . . , 7M when to connect and disconnect. Prior to or upon receiving the synchronisation signal 10, the control unit 4 may send control signals to each of the flash duration switches 7A, . . . , 7M to connect. The control unit 4 may then initiate the discharge to the flash tubes 2A, . . . , 2M by sending a control signal to the ignition circuits 12A, . . . , 12M of the flash tubes 2A, . . . , 2M indicting that ignition is to be activated. As each determined discharge interruption time tₒₚₜ for each of the at least two flash tubes 2A, . . . , 2M is reached, the control unit 4 may be configured to selectively send control signals to each of the flash duration switches 7A, . . . , 7M to disconnect, respectively.

FIG. 4 shows schematic graphs illustrating an operation of the flash apparatus 1 comprising two or more flash tubes 2A, . . . , 2M according to an embodiment of the invention. The desired colour temperature of the light emitted from a first and second flash tube 2A and 2M for a flash or flash instance is denoted by T_{des}, and the desired amount of energy to be delivered to the first and second flash tube 2A and 2M for the flash is denoted by E_{A} and E_{M}, respectively.

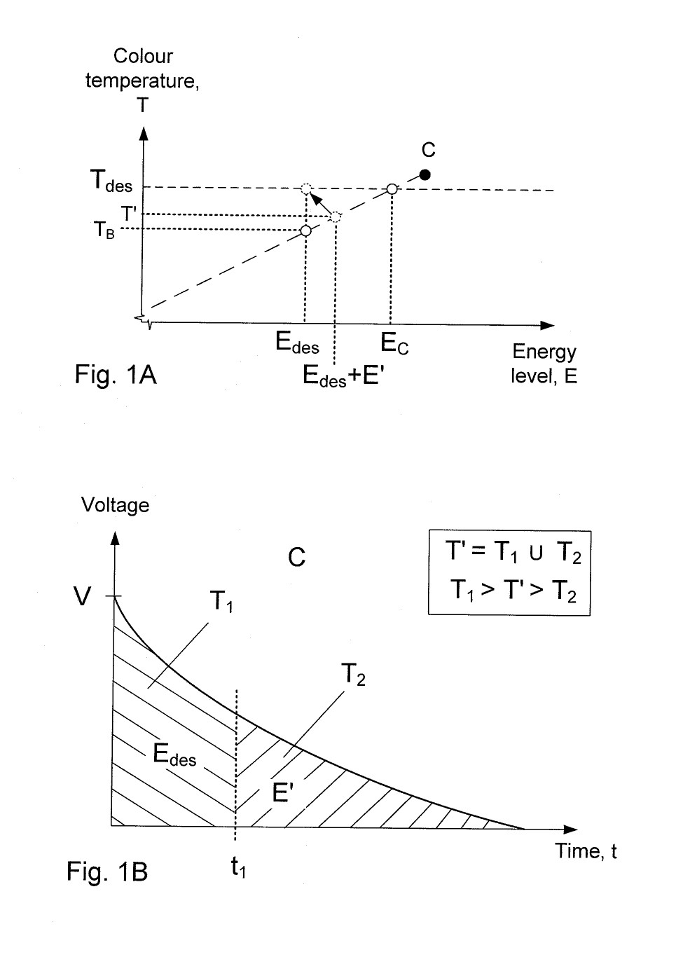

Based on the desired amount of energy E_{A} for the first flash tube 2A and the desired colour temperature setting T_{des}, a total capacitance C_{4A} for the first flash tube 2A may be determined. The total capacitance C_{4A} may comprise one or a combination of the energy storage units 3A, . . . , 3N. Furthermore, based on the desired colour temperature T_{des} and the relationships shown in FIG. 1B, a combination of an input voltage Vₒₚₜ for the first flash tube 2A and a discharge interruption time tₒₚₜ for the first flash tube 2A may be determined in dependence or based on each other. The input voltage Vₒₚₜ for the first flash tube 2A here being the sum of the charging voltages of the one or combination of energy storage units 3A, . . . , 3N comprised in the determined total capacitance C_{4A}. The combination of the input voltage Vₒₚₜ and the discharge interruption time tₒₚₜ may be determined such that the input voltage Vₒₚₜ corresponds to an amount of energy E_{A}+E′_{A}. Thus, an interruption of the discharge of the energy by the first flash tube 2A at the discharge interruption time tₒₚₜ results in that the amount of energy E′_{A} is cut off and not discharged by the first flash tube 2A, and the remaining amount of energy E_{A} has a colour temperature that is substantially the same as the desired colour temperature T_{des}.

Similarly, based on the desired amount of energy E_{M} for the second flash tube 2M and the desired colour temperature setting T_{des}, a total capacitance C_{3M} for the second flash tube 2M may be determined. The total capacitance C_{3M} may comprise one or a combination of the energy storage units 3A, . . . , 3N, however, not any one of the energy storage units 3A, . . . , 3N used for the total capacitance C_{4A} for the first flash tube 2A or another energy storage unit 3A, . . . , 3N used by another flash tube for the flash. Furthermore, based on the desired colour temperature T_{des} and the relationships shown in FIG. 1B, a combination of an input voltage Vₒₚₜ for the second flash tube 2M and a discharge interruption time tₒₚₜ for the second flash tube 2M may be determined based on each other. The input voltage Vₒₚₜ for the second flash tube 2M here being the sum of the charging voltages of the one or combination of energy storage units 3A, . . . , 3N comprised in the determined total capacitance C_{3M}. The combination of the input voltage Vₒₚₜ and the discharge interruption time tₒₚₜ may be determined such that the input voltage Vₒₚₜ corresponds to an amount of energy E_{M}+E′_{M}. Thus, an interruption of the discharge of the energy by the second flash tube 2M at the discharge interruption time tₒₚₜ results in that the amount of energy E′_{M} is cut off and not discharged by the second flash tube 2M, and the remaining amount of energy E_{M} has a colour temperature that is substantially the same as the desired colour temperature T_{des}.

It should be noted that although only described for a first and a second flash tube 2A and 2M above, this may similarly be implemented for any number of flash tubes 2A, . . . , 2M comprised in the flash apparatus 1.

Furthermore, as shown in FIG. 4, the energy level E_{A} delivered to the first flash tube 2A may be different from the energy level E_{M} delivered to the second flash tube 2M. This advantageously enables the flash apparatus 1 to select different desired energy levels for the different flash tubes 2A, . . . , 2M. This may, for example, be advantageous when using flash tubes of different types with inherently different characteristics.

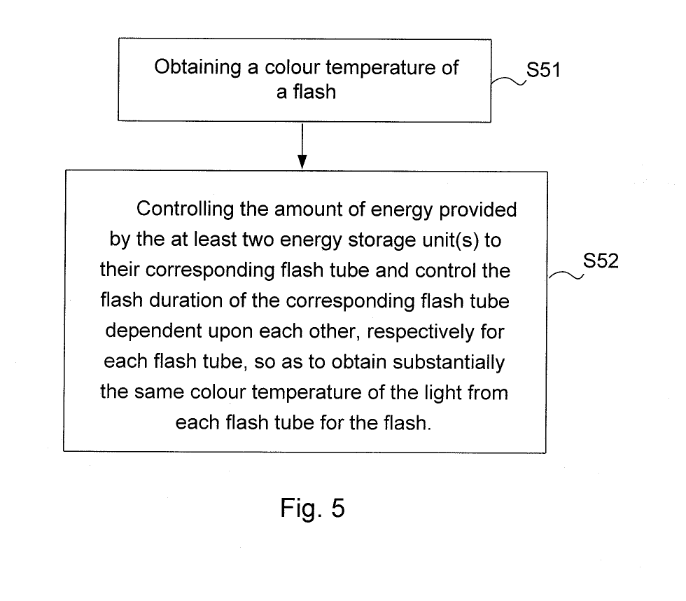

FIG. 5 shows a flowchart illustrating a method according to an embodiment of the invention. In step S51, the control unit 4 in the flash apparatus 1 may obtain a desired colour temperature T_{des} of a flash or a predetermined colour temperature, for example, as a default value in the control unit 4 or received as an input parameter by the control unit 4. In step S52, the control unit 4 in the flash apparatus 1 may control the amount of energy that is to be provided by at least one of the corresponding energy storage unit 3A, . . . , 3N to the flash tubes 2A and control the flash duration of the flash tube 2A dependent of each other. This may be done respectively for each of the flash tubes 2A, . . . , 2M, and in order to obtain substantially the received colour temperature from each flash tube 2A, . . . , 2M for a flash.

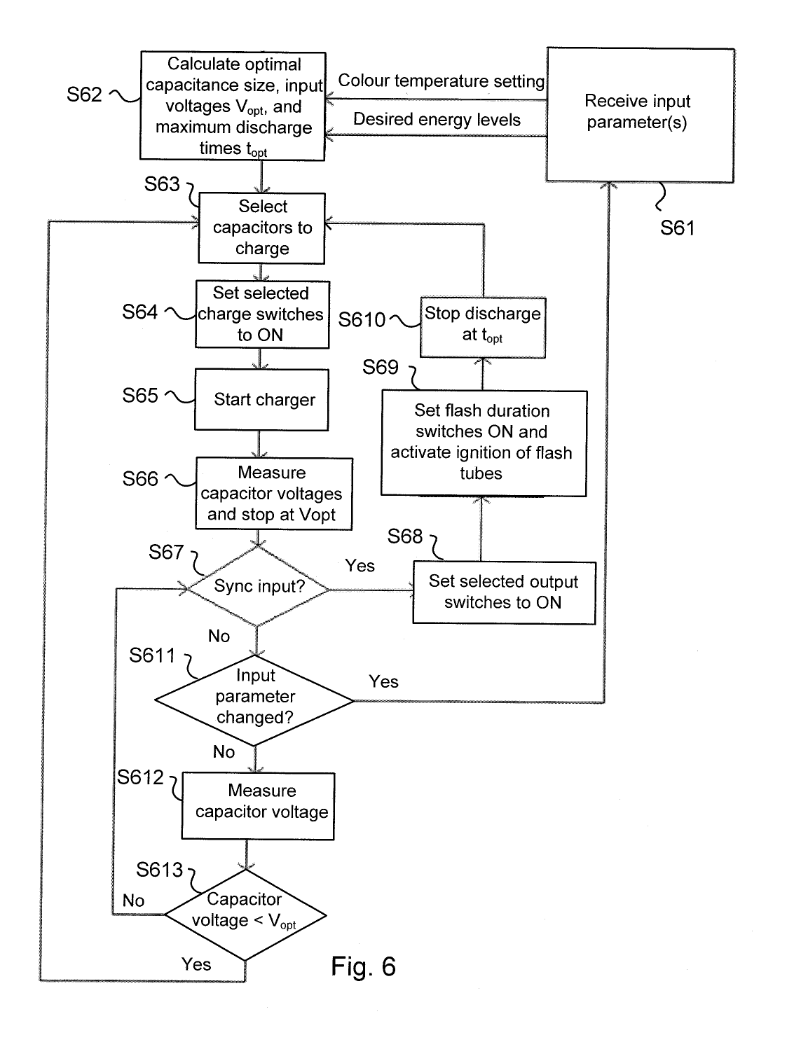

FIG. 6 shows a flowchart illustrating a method according to another embodiment of the invention. In step S61, the control unit 4 in the flash apparatus 1 may receive input signals 9 comprising input parameters. The input parameters may comprise at least a desired colour temperature T_{des} of the flash and a desired energy level or levels for the flash tubes 2A, . . . , 2M. The input parameters may further comprise the discharge characteristics of the current flash tubes 2A, . . . , 2M that are actually used in the flash apparatus 1, the impendances of the capacitors of the energy storage units 3A, . . . , 3N, and/or other impedances inherent in the circuit of the flash apparatus 1. The input parameters may also be provided as default or stored parameters in the flash apparatus 1.

In step S62, the control unit 4 may calculate suitable total capacitance sizes, input voltages Vₒₚₜ, and maximum discharge times tₒₚₜ for each of the flash tubes 2A, . . . , 2M based on at least the desired energy level(s) and the desired colour temperature T_{des}. Additionally, the calculation may further be based on and take into consideration any combination of the previously mentioned input parameters.

In step S63, the control unit 4 may, based on the calculate suitable total capacitance sizes and input voltages Vₒₚₜ, select which and how many capacitors 3A, . . . , 3N is to be used for each of the at least two flash tubes 2A, . . . , 2M, respectively. It should be noted that a single capacitor or energy storage unit 3A, . . . , 3N may only corresponds to and provide energy to a single flash tube 2A, . . . , 2M for a particular flash. In step S64, the control unit 4 may switch on the charging switches 5A, . . . , 5N corresponding to the selected capacitors 3A, . . . , 3N, i.e. switch the selected charging switches 5A, . . . , 5N into an active or closed position. This may be performed by the control unit 4 by sending control signals to the charge voltage setting means 5. In step S65, the control unit 4 may control the charging unit 8 to begin providing an output voltage to the selected capacitors 3A, . . . , 3N. This may be performed by the control unit 4 by sending control signals to the charging unit 8. In step S66, the control unit 4 may measure the capacitor voltages for each of the selected capacitors 3A, . . . , 3N and selectively switch off the selected charging switches 5A, . . . , 5N, i.e. switch the selected charging switches 5A, . . . , 5N into an non-active or open position, as the capacitors 3A, . . . , 3N reaches an energy level corresponding to the calculated input voltage Vₒₚₜ, respectively. This may be performed by the control unit 4 by sending control signals to the charge voltage setting means 5, and will charge the selected capacitors 3A, . . . , 3N to suitable energy levels.

In step S67, the control unit 4 may receive the synchronisation signal 10. The synchronisation signal 10 may indicate to the control unit 4 to initiate the flash, that is, to begin discharging the charged energy of the selected capacitors 3A, . . . , 3N through their corresponding flash tube 2A, . . . , 2M.

In case the synchronisation signal 10 is received in step S67, the control unit 4 may in step S68 switch on the output switches 6A, . . . , 6N of each of the selected capacitors 3A, . . . , 3N such that the selected capacitors 3A, . . . , 3N for each flash tube 2A, . . . , 2M are connected to the flash duration switch 7A, . . . , 7M which is associated with their corresponding flash tube 2A, . . . , 2M. This may be performed by the control unit 4 by sending control signals to the output modification means 6. In step S69, the control unit 4 may switch on the flash duration switches 7A, . . . , 7M of each of the corresponding flash tubes 2A, . . . , 2M, and send control signals to the ignition circuits 12A, . . . , 12M activating the ignition of the flash tubes 2A, . . . , 2M, respectively. Thus, the charged energy of the selected capacitors 3A, . . . , 3N will begin to discharge through their corresponding flash tubes 2A, . . . , 2M, generating the flash of the flash apparatus 1. In step S610, the control unit 4 may selectively switch off each flash duration switch 7A, . . . , 7M associated with each flash tube 2A, . . . , 2M, i.e. switch each flash duration switch 7A, . . . , 7M into an non-active or open position as each flash tube 2A, . . . , 2M reaches its calculated maximum discharge time tₒₚₜ, respectively. Thereby, substantially the same colour temperature from each flash tube 2A, . . . , 2M may be obtained during the flash in the flash apparatus 1.

Alternatively, in case the synchronisation signal 10 is not received in step S67, the control unit 4 may in step S611 monitor and check if there has been any change of the input parameters. In case a change is detected by the control unit 4, the control unit 4 may return to step S61 in order to receive new input parameter(s). According to another alternative, in case the synchronisation signal 10 is not received in step S67, the control unit 4 may in step S612 again measure the capacitor voltages for each of the selected capacitors 3A, . . . , 3N. In case the measured capacitor voltages in step S612 correspond to the calculated input voltages Vₒₚₜ, the control unit 4 may in step S613 return to step S67. However, in case any of the measured capacitor voltages in step S612 have fallen below or substantially below its calculated input voltages Vₒₚₜ, which for example may occur if the synchronisation signal 10 is not received for a longer period of time, the control unit 4 may return to step S63 in order to reselect and recharge the capacitors 3A, . . . , 3N. It should be noted that the step 611 and/or the steps S612-S613 as described above are optional alternatives to the embodiment described by the steps S61-S610.

The description above is of the best mode presently contemplated for practicing the present invention. The description is not intended to be taken in a limiting sense, but is made merely for the purpose of describing the general principles of the invention. The scope of the present invention should only be ascertained with reference to the issued claims.

1. A flash apparatus comprising at least two flash tubes and at least two energy storage units, each of said at least two energy storage units being arranged to be configured to strictly correspond to one of the at least two flash tubes for a flash, and each of said at least two energy storage units being selectively connectable to each of said at least two flash tubes to make any of or any combination of the energy storage units correspond to anyone of the flash tubes for the flash, wherein said flash apparatus is configured to
control which or which combination of the energy storage units should correspond to which flash tube, control the amount of energy provided by the at least two energy storage unit(s) to their corresponding flash tube and control the flash duration of the corresponding flash tube dependent upon each other, respectively for each flash tube, so as to obtain substantially the same colour temperature of the light from each flash tube for the flash.

2. A flash apparatus according to claim 1, wherein the flash duration for each flash tube is determined based on a desired amount of energy to be respectively provided by the energy storage units to their corresponding flash tube and the colour temperature.

3. A flash apparatus according to claim 1, wherein the amount of energy from the energy storage units provided to their corresponding flash tube is controlled by determining charging voltages for each of the energy storage units and modifying the output of the energy storage units to each flash tube.

4. A flash apparatus according to claim 3, comprising charge voltage setting means configured to charge the energy storage units for each flash tube up to the determined charging voltages.

5. A flash apparatus according to claim 4, wherein said charge voltage setting means is configured to be connected to or incorporated in a single charging unit.

6. A flash apparatus according to claim 1, comprising output modification means configured to modify the output of the energy storage units to each flash tube by selectively connecting the outputs of the energy storage units to inputs of each flash tube.

7. A flash apparatus according to claim 2, comprising flash duration control means configured to control each of the flash tubes to be activated according to the determined flash durations by selectively connecting and disconnecting the inputs of each flash tube from the outputs of the energy storage units.

8. A flash apparatus according to claim 1, wherein the amount of energy to be provided from the energy storage units to their corresponding flash tube is further based on the discharge characteristics of the flash tubes actually used, the impedance of capacitors in the corresponding energy storage units for each flash tube, and/or further impedance elements present in the flash apparatus.

9. A flash apparatus according to claim 1, wherein each of the at least two flash tubes are exchangeable flash tubes which comprise an impedance, a size and/or a shape that is different in respect to each other.

10. A method for use in a flash apparatus comprising at least two flash tubes and at least two energy storage units, each of said at least two energy storage units being arranged to be configured to strictly correspond to one of the at least two flash tubes for a flash, and each of said at least two energy storage units being selectively connectable to each of said at least two flash tubes to make any of or any combination of the energy storage units correspond to anyone of the flash tubes for the flash, said method comprising the steps of:
controlling which or which combination of the energy storage units should correspond to which flash tube, controlling the amount of energy provided by the at least two energy storage unit(s) to their corresponding flash tube and controlling the flash duration of the corresponding flash tube dependent of each other, respectively for each flash tube, so as to obtain substantially the same colour temperature from each flash tube for a flash.

11. A method according to claim 10, further comprising the steps of:
determining the flash duration for each flash tube based on a desired amount of energy to be respectively provided by the energy storage units to their corresponding flash tube and the colour temperature.

12. A method according to claim 10, further comprising the step of:
controlling the amount of energy from each of the energy storage units provided to their corresponding flash tube by determining charging voltages for each of the corresponding energy storage units and modifying the output of the corresponding energy storage units to each flash tube.

13. A method according to claim 10, further comprising the step of:
modifying the output of the corresponding energy storage units to each flash tube by selectively connecting or disconnecting the outputs of the corresponding energy storage units to inputs of each flash tube.

14. A method according to claim 11, further comprising the step of:
controlling each of the flash tubes to be activated according to the determined flash durations by selectively connecting or disconnecting of the inputs of each flash tube from the outputs of the energy storage units.

15. A computer program product for use in a flash apparatus comprising at least two flash tubes and at least two energy storage units, each of said at least two energy storage units being arranged to be configured to strictly correspond to one of the at least two flash tubes for a flash, and each of said at least two energy storage units being selectively connectable to each of said at least two flash tubes to make any of or any combination of the energy storage units correspond to anyone of the flash tubes for the flash, said computer program product comprising computer readable code means, which when run in a control unit in the flash apparatus causes said flash apparatus to perform the steps of:
controlling which or which combination of the energy storage units should correspond to which flash tube, controlling the amount of energy provided by the at least two energy storage unit(s) to their corresponding flash tube and controlling the flash duration of the corresponding flash tube dependent of each other, respectively for each flash tube, so as to obtain substantially the same colour temperature from each flash tube for a flash.

16. A computer program product according claim 15, comprising computer readable code means, which when run in the processing unit in the flash apparatus causes said the flash apparatus to further:
determine the flash duration for each flash tube based on a desired amount of energy to be respectively provided by the energy storage units to their corresponding flash tube and the colour temperature.

17. A computer program product according claim 15, wherein said code means is stored on a readable storage medium.
